(19) United States
(12) Patent Application Publication
(10) Pub. No.: US 2026/0246972 A1
(43) Pub. Date: Aug. 20, 2026

(54) PREDICTION DEGREE BASED MOTION ESTIMATION

(71) Applicant: InterDigital CE Patent Holdings, SAS, Paris (FR)

(72) Inventors: Jean-Eudes Marvie, Plerin (FR); Olivier Mocquard, Rennes (FR)

(21) Appl. No.: 19/489,531

(22) PCT Filed: Jun. 27, 2024
(86) PCT No.: PCT/EP2024/068151

§ 371 Date: Dec. 2, 2025

(30) Foreign Application Priority Data
Jul. 7, 2023 (EP) 23306155.5

(51) Int. Cl. H04N 19/597; H04N 19/17; H04N 19/70; H04N 19/88

(52) U.S. Cl. CPC H04N 19/597; H04N 19/17; H04N 19/70; H04N 19/88

(57) ABSTRACT

Example embodiments provide encoding and decoding methods and apparatus for coding of mesh data. In example embodiments, a mesh decoding method includes: obtaining mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and decoding motion information of the vertices according to the second ordering of the vertices.

### CROSS REFERENCE

The present application claims priority from European Patent Application No. 23306155.5, filed 7 Jul. 2023, entitled “Prediction Degree Based Motion Estimation,” which is incorporated herein by reference in its entirety.

### BACKGROUND

The present disclosure relates to systems and methods for encoding and decoding a mesh based on edgebreaker technology. Edgebreaker is a technology that is capable of efficiently coding the connectivity of a triangular mesh. In its most straightforward implementation, a mesh encoded using edgebreaker is represented by an ordered series made up of the symbols, C, L, E, R, and S, called the “CLERS” sequence. Generally speaking, starting with an initial triangle, these symbols describe different ways to attach a new triangle, providing information on whether or how different edges of the new triangle are connected to one or more of the existing triangles. Edgebreaker technology is described in greater detail, for example in the following sources:
J. Rossignac, “3D compression made simple: Edgebreaker with ZipandWrap on a corner-table,” in Proceedings International Conference on Shape Modeling and Applications, Genova, Italy, 2001. Describes decoding in a forward direction with the use of a corner table (CT) representation of the mesh, which leads to a very compact algorithm.
H. Lopes, G. Tavares, J. Rossignac, A. Szymczak and A. Safonova, “Edgebreaker: a simple compression for surfaces with handles,” in ACM Symposium on Solid Modeling and Applications, Saarbrucken, 2002.
J. Rossignac, “Edgebreaker: Connectivity compression for triangle meshes,” GVU center, Georgia Institute of Technology, 1999. Describes decoding in a forward direction using a half-edge representation.
J. Rossigniac, “Course on triangle meshes and corner table,” 2006.
M. Isenburg and J. Snoeyink, “Spirale Reversi: Reverse decoding of the Edgebreaker encoding,” Computational Geometry, vol. 20, pp. 39-52, 2001. Describes the “spiral reversi” technique, which uses a half edge representation, but performing the decoding in a reverse manner, which leads to faster decoding of O(n).

Following the MPEG V-Mesh (now renamed V-DMC) call for proposals, the solution proposed by Apple was selected to become the foundation of the MPEG V-Mesh Test Model (TM). The proposal is described in K. Mammou, J. Kim, A. Tourapis and D. Podborski, “m59281-[V-CG] Apple's Dynamic Mesh Coding CfP Response,” Apple Inc, 2022. Summary figures from the proposal are provided in FIGS. 1A-1B and FIGS. 2A-2B of the present disclosure.

The VDMC test model (TM version v4) proposes a motion detection stage where two variants of a mesh are candidates for a frame: the original base mesh M′ₛ(i) (see FIG. 1A and FIG. 2A for static path), or a base mesh using the topology of the previous frame M′ₘ(i) (see FIG. 1B and FIG. 2B for motion path). In the latter case, some encoding of the vertex motion is used, and the topology is skipped since it is the one from the previous frame that is used.

The vertex motion is encoded using motion predictors for each vertex vₙ, computed by looking at the neighborhood of vₙ if some already predicted vertex motion is available. The vertices are processed in the order they are reconstructed by the base mesh decoder (see FIG. 2B, block “Reconstruct base mesh”). This order strongly impacts the motion predictions if the vertices are not enumerated in an efficient manner. For instance, the motion estimation of a vertex will not be possible where none of the neighbor vertices already has some estimated motion, hence leading to a non-estimation branch for this vertex and bad coding performance.

### SUMMARY

A mesh decoding method according to some embodiments includes: obtaining mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and decoding motion information of the vertices according to the second ordering of the vertices.

A mesh encoding method according to some embodiments comprises: encoding mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and encoding motion information of the vertices according to the second ordering of the vertices.

A mesh decoding apparatus according to some embodiments comprises one or more processors configured to perform at least: obtaining mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and decoding motion information of the vertices according to the second ordering of the vertices.

A mesh encoding apparatus according to some embodiments comprises one or more processors configured to perform at least: encoding mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and encoding motion information of the vertices according to the second ordering of the vertices.

Some embodiments include at least one processor and a computer-readable medium storing instructions for performing any of the methods described herein.

Some embodiments include a computer-readable medium (which may be non-transitory) storing instructions for performing any of the methods described herein.

Some embodiments include a computer-readable medium storing a mesh encoded according to any of the encoding methods described herein.

Some embodiments include a signal conveying a mesh encoded according to any of the encoding methods described herein.

### BRIEF DESCRIPTION OF THE DRAWINGS

FIG. 1A is a functional block diagram of an example mesh encoding system using intra frame encoding.

FIG. 1B is a functional block diagram of an example mesh encoding system using inter frame encoding.

FIG. 2A is a functional block diagram of an example mesh decoding system using intra frame decoding.

FIG. 2B is a functional block diagram of an example mesh decoding system using inter frame decoding.

FIG. 3 illustrates an example of an edgebreaker mesh codec according to some embodiments.

FIG. 4 is a flow chart of an encoding process according to some embodiments.

FIG. 5 is a flow chart of a decoding process according to some embodiments.

FIG. 6 illustrates an example of a portion of a mesh illustrating information that may be stored in a corner table data structure.

FIG. 7 illustrates an example of an extended corner table to support UV coordinates attribute and normal vector attributes.

FIG. 8 illustrates an extended Corner Table data structure used in memory for the algorithmics.

FIG. 9 illustrates a process in an example embodiment in which a hole in the surface of a mesh is filled with a dummy vertex and dummy triangles.

FIGS. 10A-10B illustrate the prediction degree of a vertex. Solid shaded triangles are those in which all vertices have been traversed. The prediction degree of the bold vertex in FIG. 10A is four. The prediction degree of the bold vertex in FIG. 10B is three.

FIG. 11 illustrates an example extension of the decode procedure of MPEG edgebreaker to support reindexing based on prediction degree of the vertices.

FIG. 12 illustrates code for an example reindexing procedure postReindex.

FIG. 13 shows the impact on the motion coding in V-DMC on the LD profile, using the reindexing option versus not using the reindexing option.

FIG. 14 is a flow diagram illustrating a decoding method according to some embodiments.

FIG. 15 is a flow diagram illustrating a encoding method according to some embodiments.

FIG. 16 is a block diagram of an example of a system in which various aspects and embodiments are implemented.

### DETAILED DESCRIPTION

### Overview of an Example Edgebreaker Codec

Edgebreaker (EB) is a technology for encoding and decoding (collectively “coding”) the topology (connectivity and handles) of the mesh, which is the core of the algorithm, and proposes the use of predictors for the positions of the vertices to generate some entropy coding efficient data.

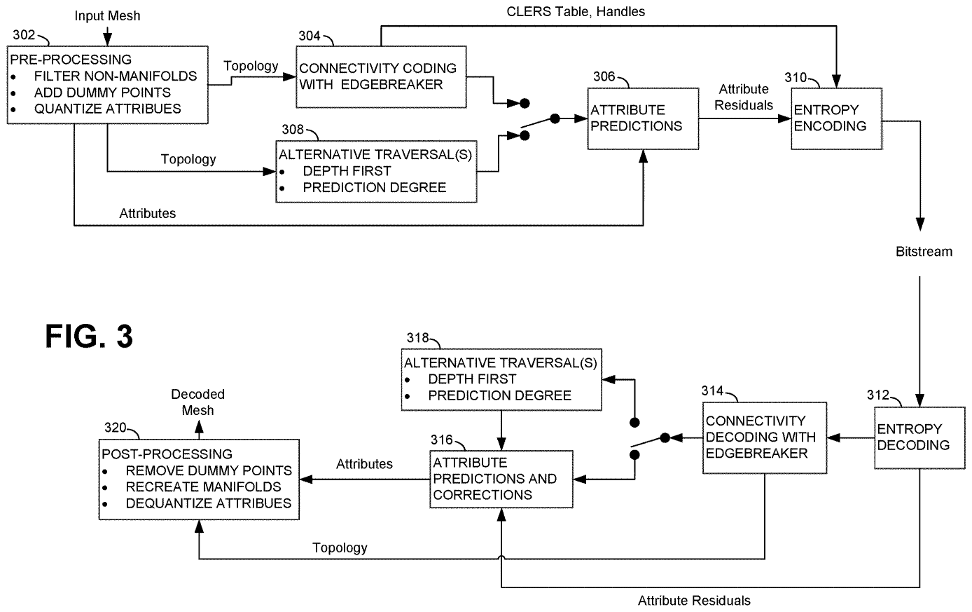

FIG. 3 illustrates an example of an edgebreaker mesh codec according to some embodiments. The top row is the encoding line, and the bottom row is the decoding line. As illustrated in FIG. 3, example embodiments include some or all of the following. During encoding, pre-processing 302 may be used to clean potential connectivity issues (non-manifolds edges and vertices) that can exist on the input mesh. This cleanup is performed because the edgebreaker algorithm by itself does not work on meshes having such connectivity issues. In some embodiments, cleaning non manifold edges and vertices involves duplicating a number of points. Some embodiments keep track of those duplicated vertices to merge those when decoding. This enables to reduce the number of points in the decoded mesh but calls for sending some additional information in the bitstream. In some embodiments, this pre-processing further includes adding some dummy points to fill potential holes on the surface because the edgebreaker algorithm alone does not handle holes. Example embodiments operate to fill the holes before encoding and recreate the holes after decoding. Example embodiments use “virtual” dummy points and generate and encode dummy triangles attached to these dummy points, but the 3D positions of those points are not encoded or decoded. In some embodiments, the vertex attributes are quantized if needed. Those attributes can be provided to the coder already quantized.

Example embodiments encode the connectivity of the mesh at 304 using a modified version of the edgebreaker algorithm from which generates a CLERS table (a table made of ‘C’, ‘L’, ‘E’, ‘R’, and ‘S’ symbols). This stage also generates some tables in memory that are used for the attribute prediction stage. The vertex attributes are then predicted, starting by the position ones. Then, other attributes are predicted 306, eventually relying on the position predictions, which is the case for the texture UV coordinates. The prediction may proceed in a topology-based order determined by the edgebreaker encoding. Alternatively, the prediction may proceed using a different order, such as a depth-first traversal or a prediction-degree-based traversal. At 308, the alternate traversal is performed. The encoder may signal in the bitstream information indicating which type of traversal is used for attribute prediction. The encoder may test different traversal types (e.g. a topology-based traversal type and one or more alternative traversal types) and encode the mesh using whichever traversal type provides the best performance (e.g. the greatest compression). Configuration and metadata are also provided in the bitstream, the CLERS table, some other connectivity and all the attribute prediction residuals are entropy coded 310 and added to the bitstream.

In an example decoding method, all of the entropy coded sub-bitstreams are decoded 312. We reconstruct the mesh connectivity 314 using the CLERS table and the edgebreaker algorithm. We also add some extra information to manage the handles, which describe the topology. We use the mesh connectivity as well as a minimal set of vertex positions expressed in 3D coordinates to predict all the other per-vertex positions 316. Where the traversal type is an alternative traversal type, the decoder performs the appropriate alternative traversal at 318. Where the traversal type is based on the topology of the mesh as reconstructed in 314, an alternative traversal is not needed. We then apply the attribute residuals to correct the predictions and obtain the reconstructed vertex positions. Then the other attributes are decoded, potentially relying on decoded positions, as for UV coordinates. The connectivity of attributes using separate index tables is reconstructed using per a per edge binary seam information that is entropy coded.

In a post-processing stage 320, we do remove the dummy triangles, we optionally recreate the non-manifold issues in case the coder is configured to perform lossless coding, and we optionally dequantize the vertex attributes if the model was quantized by encoder.

Example embodiments encode the connectivity of the mesh using a modified version of the edgebreaker algorithm which generates a CLERS table (a table made of ‘C’, ‘L’, ‘E’, ‘R’, and ‘S’ symbols). This stage also generates some tables in memory that are used for the attribute prediction stage. The vertex attributes are then predicted, starting by the position ones. Then, other attributes are predicted, eventually relying on the position predictions, which it is the case for the texture UV coordinates. Configuration and metadata are also provided in the bitstream, the CLERS table, some other connectivity and all the attribute prediction residuals are entropy coded and added to the bitstream.

In an example decoding method, all of the entropy coded sub-bitstreams are decoded. We reconstruct the mesh connectivity using the CLERS table and the edgebreaker algorithm. We also add some extra information to manage the handles, which describe the topology. We use the mesh connectivity as well as a minimal set of vertex positions expressed in 3D coordinates to predict all the other per-vertex positions. We then apply the attribute residuals to correct the predictions and obtain the reconstructed vertex positions. Then the other attributes are decoded, potentially relying on decoded positions, as for UV coordinates. The connectivity of attributes using separate index tables is reconstructed using per a per edge binary seam information that is entropy coded.

In a post-processing stage, the dummy triangles are removed. Optionally, the non-manifold issues are recreated in case the coder is configured to perform lossless coding. The vertex attributes may be dequantized if the model was quantized by encoder.

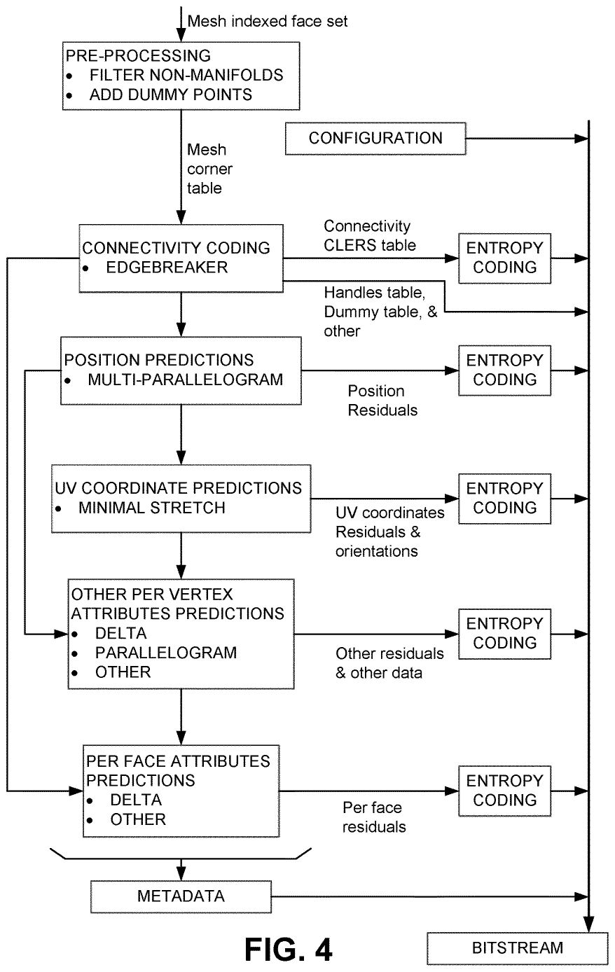

FIG. 4 is a flow chart of an encoding process according to some embodiments.

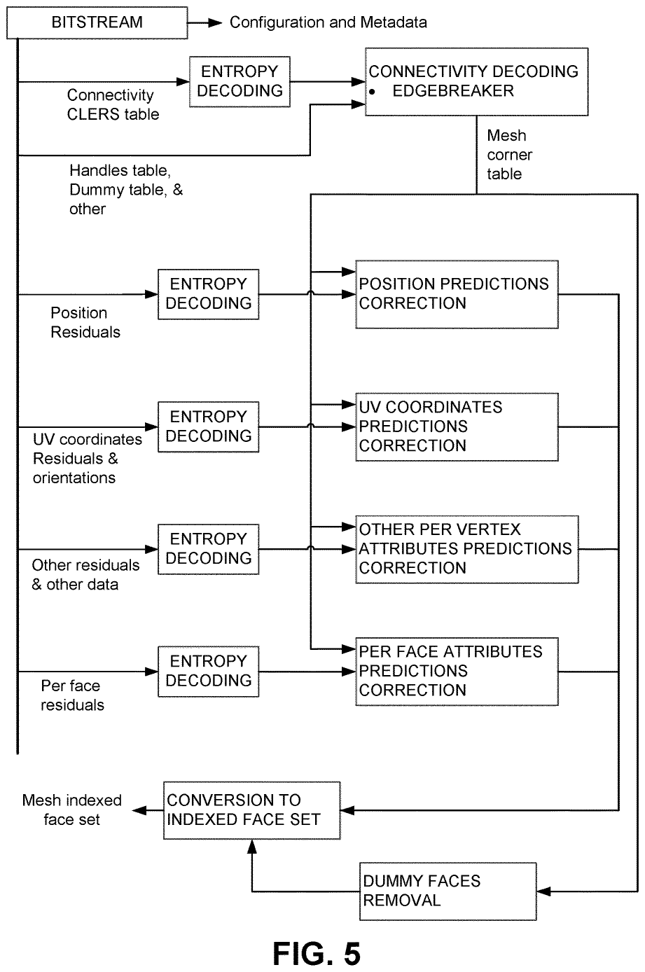

FIG. 5 is a flow chart of a decoding process according to some embodiments.

### Extended Corner Table.

A corner table data structure to represent a mesh is described in J. Rossignac, “3D compression made simple: Edgebreaker with ZipandWrap on a corner-table,” in Proceedings International Conference on Shape Modeling and Applications, Genova, Italy, 2001; and further described in J. Rossigniac, “Course on triangle meshes and corner table,” 2006.

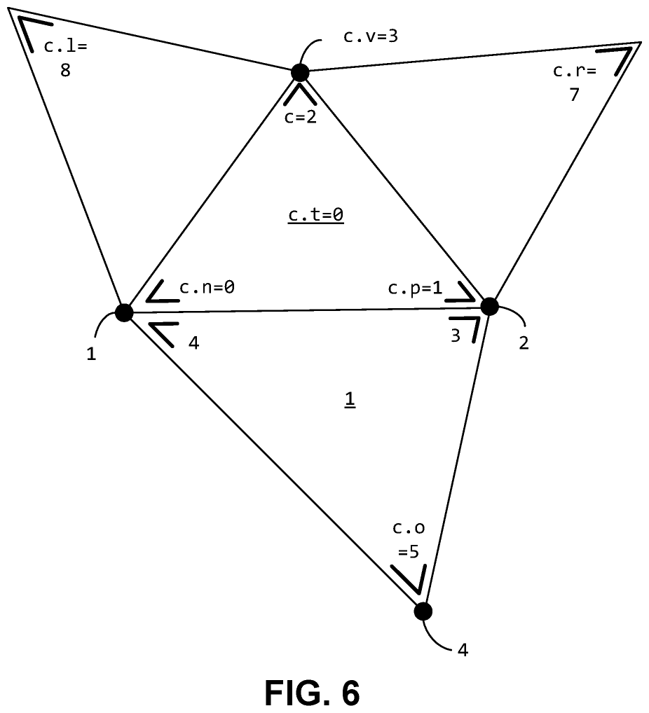

An example of a corner table data structure is presented in FIG. 6. It is made of a table of vertex indices V and a table of opposite corners O. It may also be referred to as an OV table. In addition, a third table stores the actual positions of each vertex. Those vertices are referenced by the V table.

FIG. 6 illustrates a portion of a triangular mesh illustrating information that may be stored in a corner table (also referred to as an OV table). For each corner index c of a corner in the corner table, the notation c.v=3 identifies the index of the vertex at which that corner is located. The index c.t=0 is the index of the triangle that includes corner c. Within that triangle, the index c.n=0 identifies the next corner (in a counterclockwise direction), and c.p=1 identifies the previous corner. The index c.o identifies the corner that is opposite to the corner c. For example, in FIG. 6, corner c.o=5 is opposite corner c=2 (and vice versa). The index c.l identifies the corner to the left of corner c, and the index c.r identifies the corner to the right of corner c. The connectivity as shown in FIG. 6 may be recorded in a corner table with entries that include the following:

| Corner | Vertex | Opposite Corner |
|---|---|---|
| Index | Index | Index |
| 0 | 1 | 7 |
| 1 | 2 | 8 |
| 2 | 3 | 5 |
| 3 | 2 | 9 |
| 4 | 1 | 6 |
| 5 | 4 | 2 |

The “corner index” column does not need to be stored in the table because it corresponds to the position of each row within the table. The triangle index for each corner can be calculated as

$$c . t = INT ( c / 3 )$$

Thus, corners 0, 1, and 2 are all in the triangle with index 0; corners 3, 4, and 5 are all in the triangle with index 1; and so on. Additional relationships among entries in the corner table may be expressed as follows:

$$c . n = 3 c . t + ( c + 1 ) MOD 3$$

$$c . p = c . n . n$$

$$c . l = c . p . o$$

$$c . r = c . n . o$$

In some embodiments, an additional table may be used to store position coordinates of each vertex.

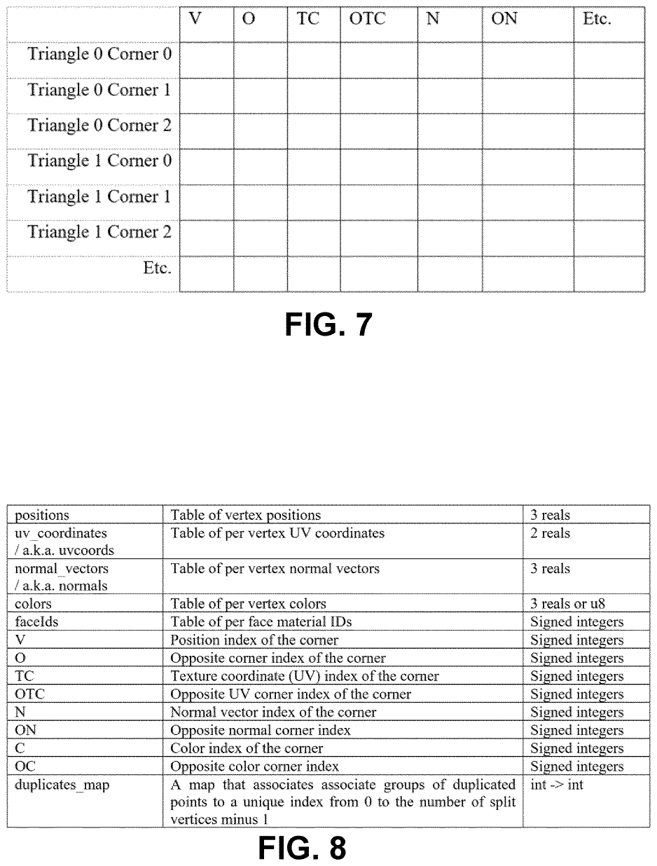

FIG. 7 illustrates an example of an extended corner table to support UV coordinates attribute and normal vector attributes, both using separate indexing tables, resp. TC/OTC and N/ON. Texture coordinates and normal vectors are stored in two other separate tables.

Example embodiments extend the corner table data structure to support other attributes with or without secondary attribute indices, as illustrated in FIG. 7. In case the mesh does not have separate indices to dereference the UV coordinates attributes, example embodiments include a table of UV coordinates alongside the position table. The UV coordinates table is then dereferenced using V as for the position. Otherwise, some embodiments also add two tables TC and OTC to code the connectivity of (to dereference) the UV coordinates. TC is used to store UV coordinates indices and OTC to store the opposite corners for the UV connectivity. The same principle may be applied to add support for per vertex normal (N/ON/normal_vectors) or per vertex colors (C/OC/colors).

FIG. 8 illustrates an extended Corner Table data structure used in some embodiments. As seen in FIG. 8, information from different columns of FIG. 7 (and/or additional information) may be stored in separate tables to provide more flexibility. FIG. 8 summarizes the data structures used in some embodiments to store the information of an extended corner table as used herein. This approach can be extended for any per vertex attribute type, to use or not dedicated index tables modeled using the pair (index table/opposite table). Per face IDs are included in the table in some implementations.

### Dummy Vertices.

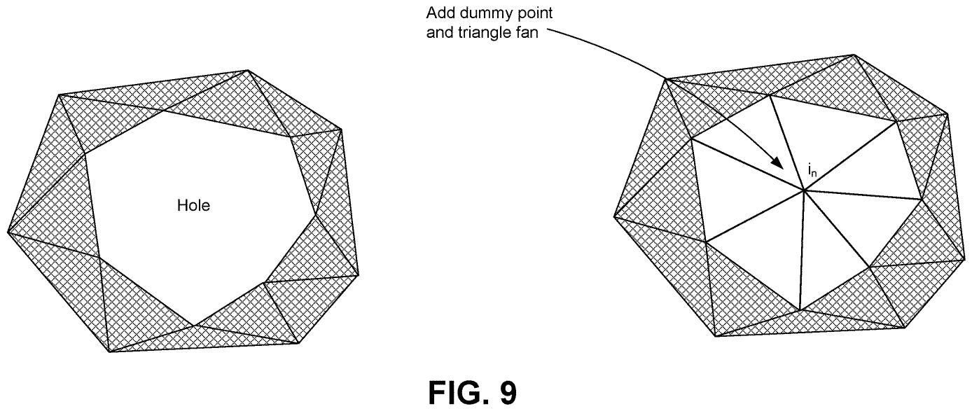

FIG. 9 illustrates a process in an example embodiment in which a hole in the surface of a mesh is filled with a dummy vertex and dummy triangles. In is the index of the dummy point in the vertex table

One known method of handling meshes with boundaries (also named meshes with holes) is to fill each hole with a dummy point and connect this new vertex to the border of the hole using a fan of triangles. The mesh is then encoded/decoded as if no hole was present. Some data to express which points are dummy is encoded in the bitstream so the point and its associated dummy triangles (from the fan) can be removed after the decoding. In some such techniques, the dummy points are encoded using fake attribute values (usually from interpolation). In other techniques, the indices of dummy points are tracked, and attributes (e.g. position, UV coordinates, color, etc.) of the dummy points are not encoded.

### Prediction Degree Based Motion Estimation.

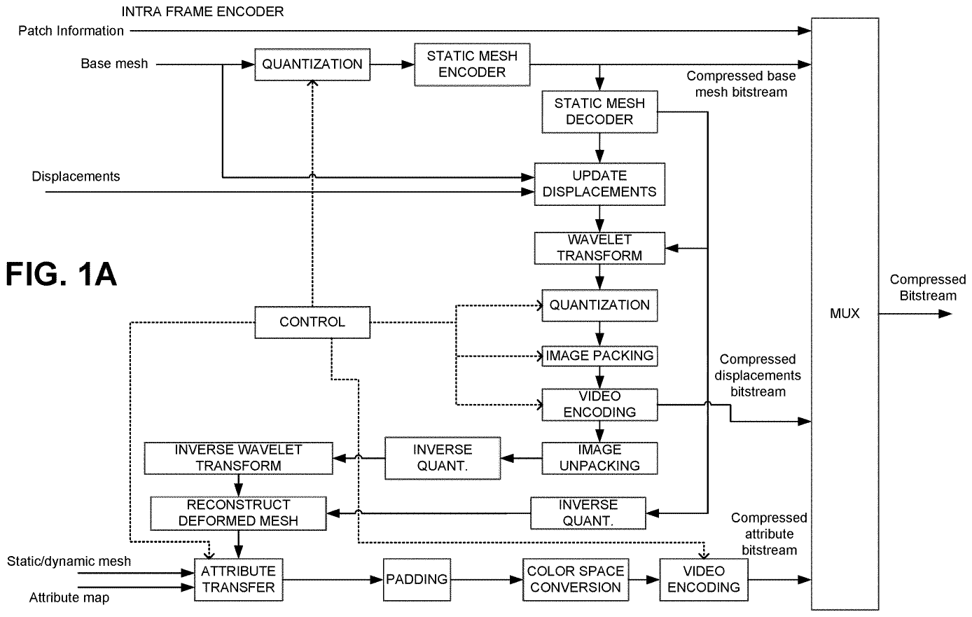

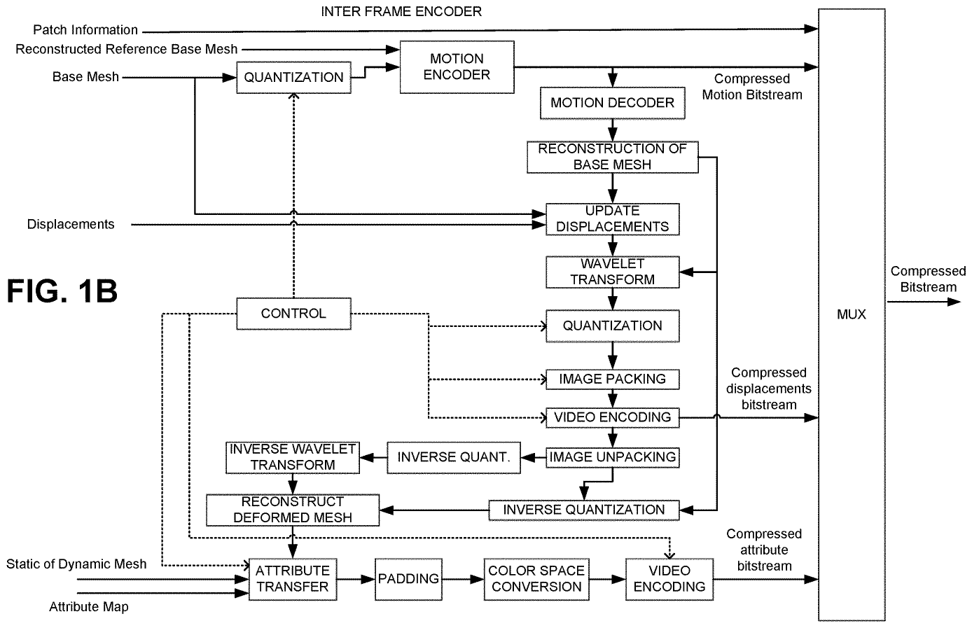

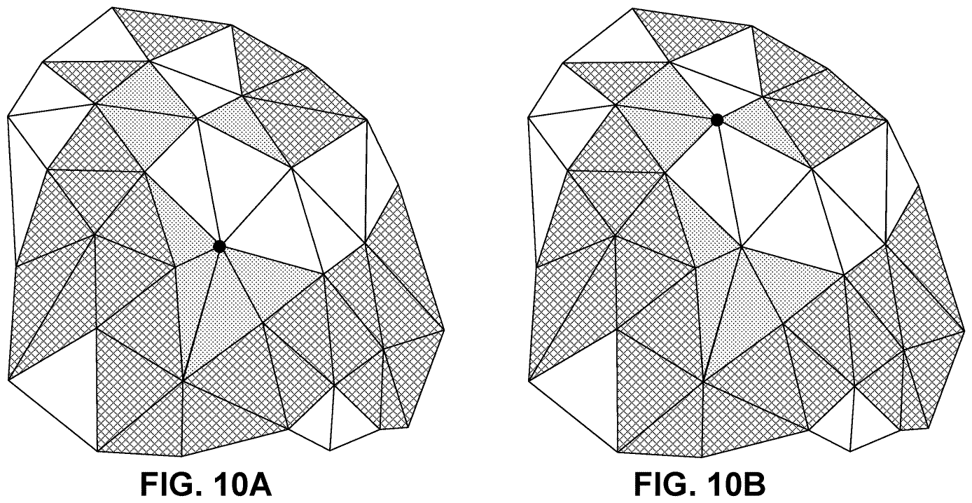

In D. Cohen-Or, R. Cohen and R. Irony, “Multi-way Geometry Encoding,” Transactions on Computational Science, 2002 (hereinafter Cohen-Or et al.), an approach of vertex traversal (ordering) is presented to improve the multi-parallelogram prediction for static meshes. FIG. 1 of Cohen-Or et al. provides a good visualization of multi-parallelogram prediction. FIGS. 10A-10B of the present disclosure illustrate the prediction degree of a vertex. Solid shaded triangles are those in which all vertices have been traversed. The prediction degree of the bold vertex in FIG. 10A is four. The prediction degree of the bold vertex in FIG. 10B is three. To summarize, the prediction degree of a vertex is the number of neighbor “triangles” for which vertex predictions have already been solved by the decoder. Cohen-Or et al. proposes to perform an ordering (a vertex traversal) of the vertices to increase the average prediction degree of vertices as they are visited.

As discussed in Cohen-Or et al., computationally generating the traversal order might be costly. Google Draco, implements a fast greedy version of this approach for their static mesh coder. Code for this approach is available at <https://github.com/google/draco/blob/master/src/draco/compression/mesh/traverser/max_prediction_degree_traverser.h>

This traversal improves the multi-parallelogram predictions once the topology is encoded/decoded by the edge breaker algorithm.

Google Draco also proposes another faster but less efficient depth first traversal method. Code for this approach is available at <https://github.com/google/draco/blob/master/src/draco/compression/mesh/traverser/depth_first_traverser.h>

Both may lead to better performances than basic EB traversal, with different complexities.

Example embodiments use vertex reordering to enhance the quality of the motion estimation predictors. Such techniques maybe used, for example, in the VDMC test model.

Example embodiments reorder the output of the base mesh decoder at the encoding and at the decoding so that the motion estimator (e.g. from VDMC) benefits from a well sorted set of vertices that tend to increase the average prediction degree if processed in the given order.

In some embodiments, a flag is provided (e.g. in the VDMC syntax) indicating whether or not re-indexing is being used.

VDMC uses an “external” base mesh codec (the MPEG one, stored a separate “space”).

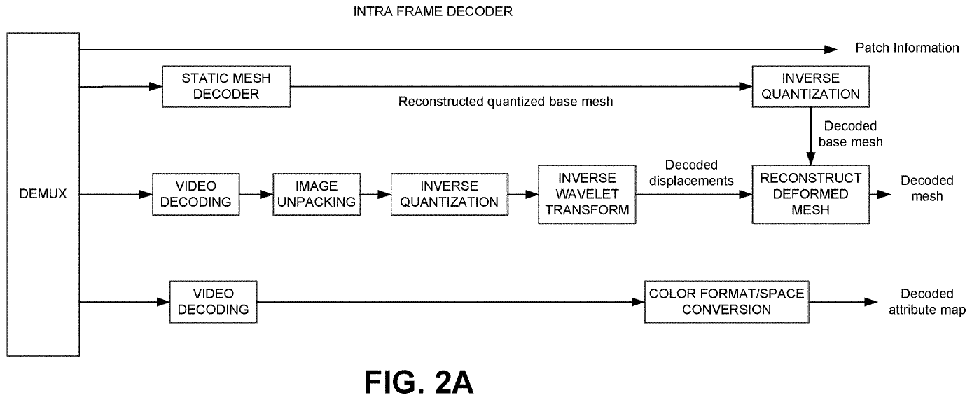

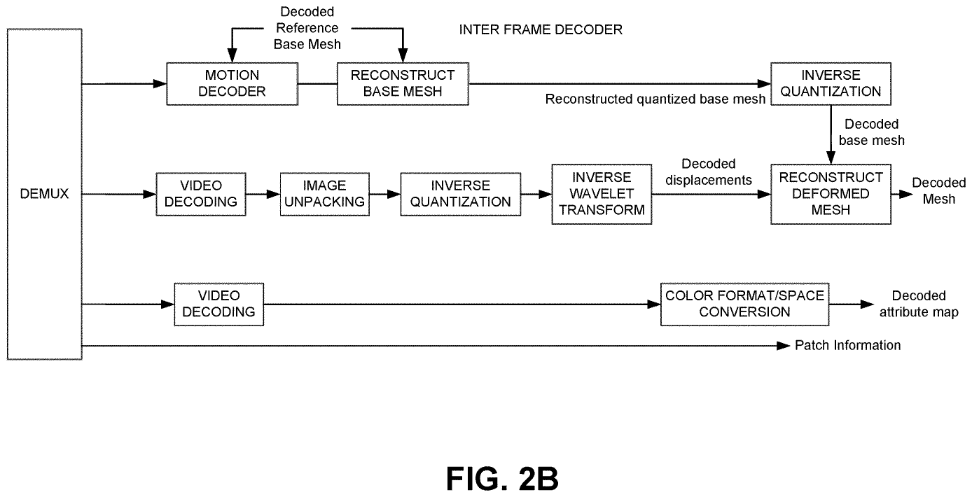

In some embodiments, re-indexing is performed by a static base mesh decoder. The reindexing may be performed at the end of the static base mesh decoding (the blocks “Static mesh decoder” of FIGS. 1A and 2A. The base mesh decoder may have a standardized interface for VDMC.

In some embodiments, reindexing is not performed by the base mesh decoder as in the embodiments described above, but instead is performed outside the base mesh decoder, e.g. by a VDMC codec. In some such embodiments, the reindexed static base mesh may be available for processing at all subsequent stages of encoding and/or decoding, e.g. by an VDMC codec.

In further embodiments, reindexing is performed outside the base mesh decoder and is limited to pre-processing of the VDMC codec motion block that makes the reindexed static base mesh available only for motion coding/decoding.

Reindexing of the mesh has not been found to lead to a negative impact on stages of the encoding/decoding process that are not related to motion (especially displacements coding).

Some embodiments are implemented as a variation on static mesh coding as described in, for example, J.-E. Marvie and O. Mocquard, “m63344—[V-DMC][EE4.4]-an-efficient-Edgebreaker-implementation,” MPEG meeting 142, Antalya (hereinafter “Marvie & Mocquard”).

Some such embodiments adapt the vertex degree traversal function from Draco which, like the system of Marvie & Mocquard, runs on a corner table.

In some embodiments, the first corner of each connected component is stored in a table, which may be named ccStartCorners.

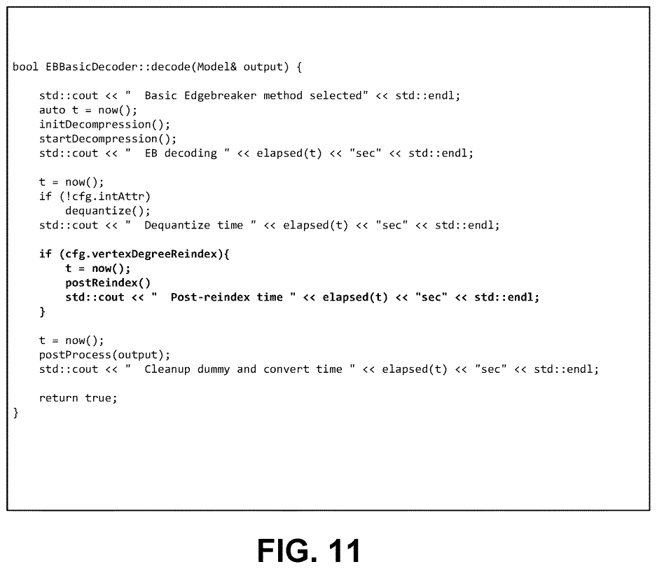

Example embodiments may modify the edgebreaker decoding procedure using code as depicted in FIG. 11. As shown in this example, if the cfg.vertexDegreeReindex flag is true, then reindexing is performed using postReindex. In some implementations, this flag is set by the VDMC codec through the static mesh codec interface; it comes as an encoder input and is saved in the V-DMC bitstream. The reindex statement occurs after the decoding, once the corner table (named_ovTable in some implementations) has been fully reconstructed. In some embodiments the reindexing occurs before the post processing that eventually removes any dummy points in the mesh.

FIG. 11 illustrates an example extension of the decode procedure of MPEG edgebreaker to support reindexing based on prediction degree of the vertices. Code of particular relevance to the present disclosure is shown in bold.

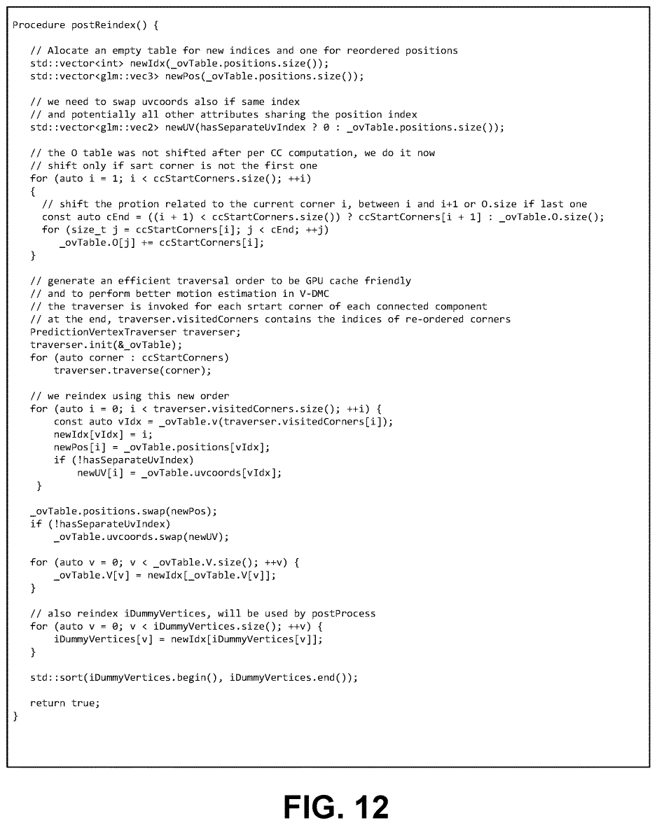

Code for an example reindexing procedure postReindex is illustrated in FIG. 12. In this embodiment, the reindexing is performed as follows:
Allocate two new tables: one to store the new vertex indices newIdx and the second newPos to store the new positions (which will be moved to fit the new indices).
Then for each start corner, run the traverser that stores the list of traversed corners in the output table traverser.visitedCorners. At the end of the process, the table visitedCorners contains a set of corners enumerated following best degree for their associated vertex in the corner table.
The table visitedCorners is then scanned linearly to compute the reindexing. At each step, the vertex index vIdx associated with the current corner is obtained by looking in the corner table _ovTable.v(traverser.visitedCorners[i]). The curent index i is then stored in the new index table newIdx at index vIdx (i.e. newIdx[vIdx]=i). This process builds an associative map between old indices and new indices. At each step, the new index and the old index are used to move the associated position at new position in the temporary array newPos.
The reordered positions are set as the new positions (swap pointer to tables).
Then loop on the V (vertex indices) table and use the newIdx map to reindex those indices.
The same operation is performed on the input table of dummy vertex indices iDummyVertices.

Motion information of the vertices may be encoded and decoded according to the order of the reindexed vertices. For example, the motion information of a current vertex may be predicted based only on motion information of vertices that (1) precede the current vertex according to the reindexing and (2) are near (e.g. neighboring or opposite) the current vertex. The reindexing is performed to achieve a vertex order that increases, on average, the number of vertices that satisfy these conditions. Such an increase is, on average, achieved using a prediction-degree-based traversal method or a depth-first traversal method as described herein.

### Example Syntax

Some embodiments further includes signaling in a bitstream (e.g. in the VDMC syntax) a flag indicating whether or not reindexing is used.

For the purpose of explanation, example embodiments are described here in the context of the V3C syntax of VDMC/MEB described in MDS22775_WG07_N00611_d9. For example, in some embodiments, the syntax described in the section “H.8.1.2.1.1 General basemesh sequence parameter set RBSP syntax” is extended by adding an element such as bmsps_intra_mesh_post_reindex_method, indicated below with a dagger (†):

| | | Descriptor |
|---|---|---|
| bmesh_sequence_parameter_set_rbsp( ) { | | |
| bmsps_sequence_parameter_set_id | | u(4) |
| bmesh_profile_tier_level( ) | | |
| bmsps_intra_mesh_codec_id | | u(8) |
| bmsps_intra_mesh_post_reindex_method | † | ue(v) |

| | |
|---|---|
| bmsps_inter_mesh_codec_id | u(8) |
| bmsps_inter_mesh_motion_group_size_minus1 | u(8) |
| bmsps_inter_mesh_max_num_neighbors_minus1 | u(8) |
| bmsps_geometry_3d_bit_depth_minus1 | u(5) |
| bmsps_facegroup_segmentation_method | ue(v) |
| bmsps_mesh_attribute_count | u(7) |
| for( i = 0; i < bmsps_mesh_attribute_count; i++ ) { | |
| bmsps_mesh_attribute_type_id[ i ] | u(4) |
| bmsps_attribute_bit_depth_minus1[ i ] | u(5) |
| bmsps_attribute_msb_align_flag[ i ] | u(1) |
| } | |
| bmsps_log2_max_mesh_frame_order_cnt_lsb_minus4 | ue(v) |
| bmsps_max_dec_mesh_frame_buffering_minus1 | ue(v) |
| bmsps_long_term_ref_mesh_frames_flag | u(1) |
| bmsps_num_ref_mesh_frame_lists_in_bmsps | ue(v) |
| for( i = 0; i < bmsps_num_ref_mesh_frame_lists_in_bmsps; i++ ) | |
| bmesh_ref_list_struct( i ) | |
| bmsps_extension_present_flag | u(1) |
| if( bmsps_extension_present_flag ) { | |
| bmsps_extension_count_minus1 | u(7) |
| } | |
| if( bmsps_extension_present_flag ){ | |
| bmsps_extensions_length_minus1 | ue(v) |
| while( more_rbsp_data( ) ) | |
| bmsps_extension_data_byte | u(1) |
| } | |
| rbsp_trailing_bits( ) | |
| } | |

In some embodiments, the semantics of the bmsps_intra_mesh_post_reindex_method element may be described as follows:
bmsps_intra_mesh_post_reindex_method indicates whether indices coming from the static mesh coder shall be reordered before motion estimation to enhance the quality of motion estimation.

In some embodiments, different values of the bmsps_intra_mesh_post_reindex_method may be mapped to different reindexing methods as shown in the following table.

| bmsps_intra_mesh_{—} | | |
|---|---|---|
| post_reindex_method | Identifier | Method |
| 0 | BM_REINDEX_NONE | Disabled |
| 1 | BM_REINDEX_DEPTH | Depth first |
| | | traversal |
| 2 | BM_REINDEX_VERTEX_{—} | Vertex |
| | DEGREE | degree |
| | | traversal |
| >2 | BM_REINDEX_RESERVED | Reserved |

### Example Flow Chart

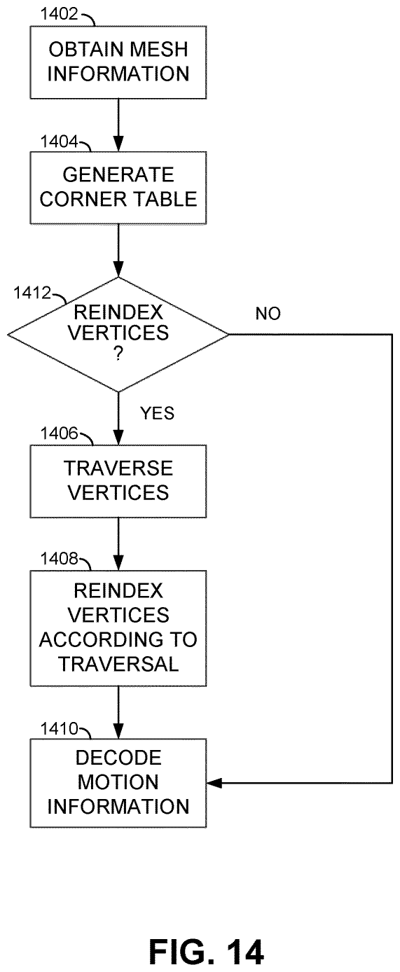

An example flow chart of a decoding method according to some embodiments is illustrated in FIG. 14. In the example mesh decoding method, mesh information is obtained at 1402 defining at least one connected component of a mesh. This information may, for example, be received in an edgebreaker format, such as in a CLERS table, through a bitstream. At least a portion of the mesh information is decoded at 1404 to generate a corner table. The corner table associates each corner of the mesh with a respective vertex from among a plurality of vertices in the mesh, as illustrated in FIGS. 6-8. The vertices have a first ordering, which may be an ordering that results from the decoding (e.g. in edgebreaker format) of the mesh geometry. The mesh is traversed at 1406 to obtain a second ordering of the vertices at 1408. Motion information of the vertices is then decoded at 1410 according to the second ordering of the vertices.

In some embodiments, the corner table includes, for each corner, a first vertex index identifying the vertex associated with the respective corner. The first vertex indices are arranged in the first ordering. The vertices are then reindexed according to the second ordering of the vertices. The decoding of motion information is performed according to the reindexing, e.g. in the order of the vertex indices of the reindexed vertices.

In some embodiments, for at least one current vertex in the mesh, motion information of the vertex is predicted based only on motion information of one or more vertices preceding the current vertex according to the second ordering. In some embodiments, for each of a plurality of vertices in the mesh, motion information of the respective vertex is predicted based only on motion information of one or more vertices preceding the respective vertex according to the second ordering. In some embodiments, the decoding of the motion information includes obtaining motion residual information (e.g. in a bitstream encoding the mesh) and adding an appropriate residual to the predicted motion information of each vertex.

Some embodiments include obtaining, from a bitstream encoding the mesh information, information indicating whether to reindex the vertices. In such embodiments, the traversing and reindexing may be performed only in response to an indication to reindex the vertices, as indicated at 1412.

Some embodiments include obtaining, from a bitstream encoding the mesh information, information identifying a type of traversal. In such embodiments, the traversing of the mesh to obtain the second ordering is performed using the identified type of traversal.

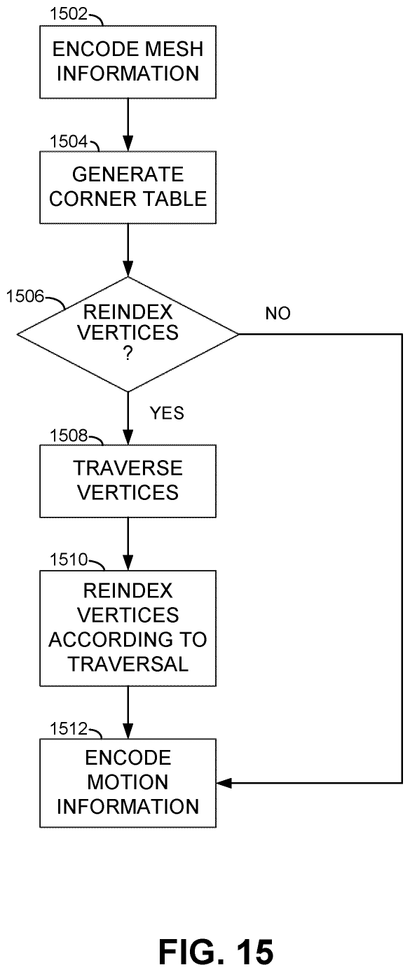

An example flow chart of an encoding method according to some embodiments is illustrated in FIG. 15. In a mesh encoding method, mesh information defining at least one connected component of a mesh is encoded at 1502. At least a portion of the mesh information is decoded at 1504 (e.g. using edgebreaker coding) to generate a corner table, the corner table associating each corner of the mesh with a respective vertex from among a plurality of vertices in the mesh, the vertices having a first ordering. A determination may be made at 1506 of whether to reindex the vertices. If a determination is made to reindex the vertices, the mesh is traversed at 1508 to obtain a second ordering of the vertices, and the vertices are reindexed at 1510 according to the second ordering. Motion information of the vertices is encoded at 1512 according to the second ordering of the vertices (if reindexing was performed) or according to the first ordering of the vertices (if reindexing was not performed). Information indicating whether to perform reindexing and/or indicating the type of traversal method used may be signaled by the encoder in a bitstream.

The traversing may be performed to increase an average prediction degree of the vertices between the first ordering and the second ordering.

In some embodiments, the traversing is performed according to a prediction-degree-based traversal method. In some embodiments, the traversing is performed according to a depth-first traversal method.

In some embodiments, the encoding of the motion information includes predicting motion information for a vertex based on the motion information of one or more previously-encoded vertices, subtracting the predicted motion information from an input motion information of the vertex to obtain a residual, and encoding the residual.

Some embodiments include at least one processor and a computer-readable medium storing instructions for performing any of the methods described herein.

Some embodiments include a computer-readable medium (which may be non-transitory) storing instructions for performing any of the methods described herein.

Some embodiments include a computer-readable medium storing a mesh encoded according to any of the encoding methods described herein.

Some embodiments include a signal conveying a mesh encoded according to any of the encoding methods described herein.

### Performance Results

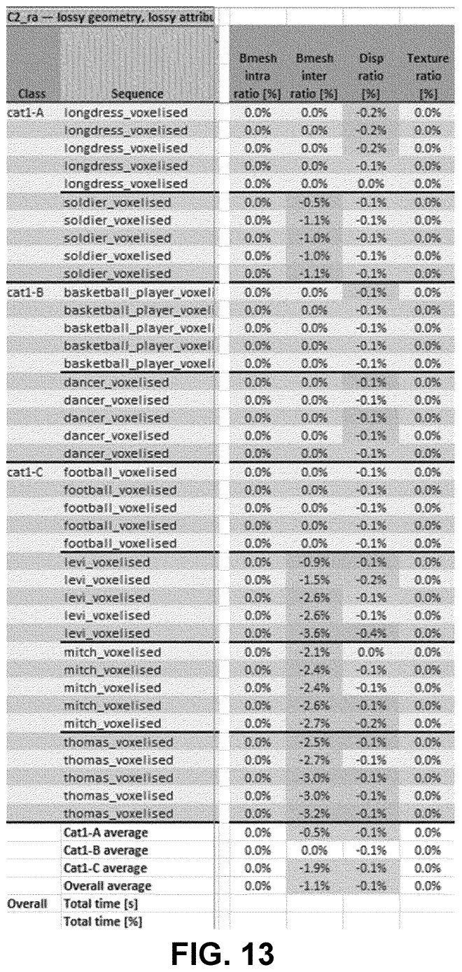

The table of FIG. 13 shows the impact on the motion coding in V-DMC on the LD profile, using the reindexing option or not. Note that only four sequences use motion coding in the anchor. The most relevant column is the total motion ratio column.

### Example System Hardware

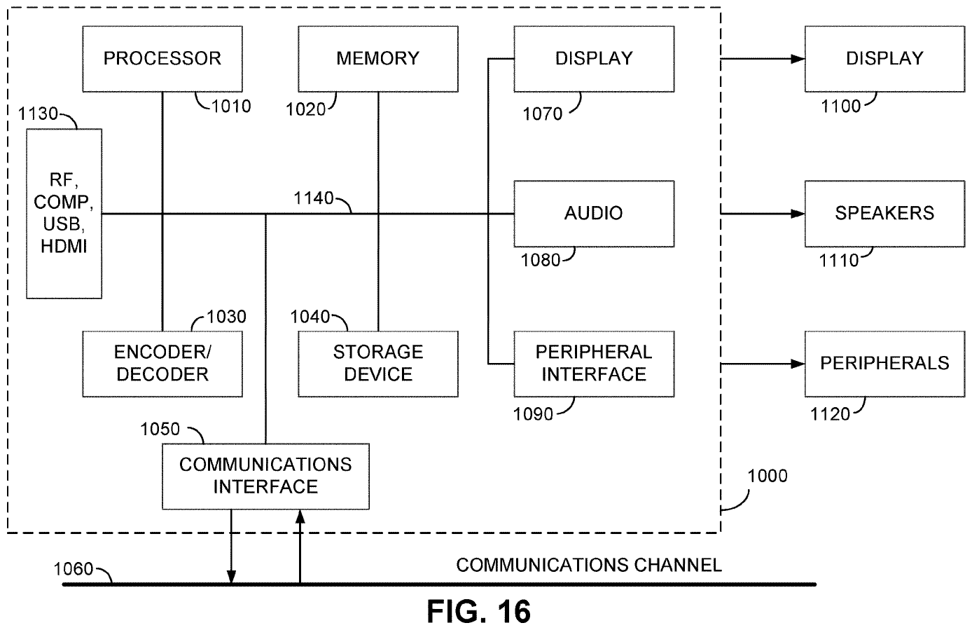

Example embodiments of encoders and/or decoders (collectively coders) configured to implement embodiments described herein may be implemented using systems such as the system of FIG. 16. FIG. 16 is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### ADDITIONAL EMBODIMENTS

A mesh decoding method according to some embodiments comprises: obtaining mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and decoding motion information of the vertices according to the second ordering of the vertices.

In some embodiments, the mesh information defining at least one connected component of a mesh is obtained in an edgebreaker format, such as a CLERS table.

In some embodiments, the corner table includes, for each corner, a first vertex index identifying the vertex associated with the respective corner, the first vertex indices being arranged in the first ordering; and the method further includes reindexing the vertices according to the second ordering of the vertices, the decoding of motion information being performed according to the reindexing.

In some embodiments, the traversing is performed to increase an average prediction degree of the vertices between the first ordering and the second ordering.

In some embodiments, the traversing is performed according to a prediction-degree-based traversal method.

In some embodiments, the traversing is performed according to a depth-first traversal method.

In some embodiments, the decoding of motion information comprises: for at least one current vertex in the mesh, predicting motion information of the vertex based only on motion information of one or more vertices preceding the current vertex according to the second ordering.

In some embodiments, the decoding of motion information comprises: for each of a plurality of vertices in the mesh, predicting motion information of the respective vertex based only on motion information of one or more vertices preceding the respective vertex according to the second ordering.

Some embodiments further include obtaining, from a bitstream encoding the mesh information, information indicating whether to reindex the vertices; wherein the traversing of the mesh to obtain the second ordering is performed only in response to an indication to reindex the vertices.

Some embodiments further include obtaining, from a bitstream encoding the mesh information, information identifying a type of traversal; wherein the traversing of the mesh to obtain the second ordering is performed using the identified type of traversal.

A mesh encoding method according to some embodiments comprises: encoding mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and encoding motion information of the vertices according to the second ordering of the vertices.

In some embodiments, the mesh information defining at least one connected component of a mesh is encoded in an edgebreaker format.

In some embodiments, the corner table includes, for each corner, a first vertex index identifying the vertex associated with the respective corner, the first vertex indices being arranged in the first ordering; and the method includes reindexing the vertices according to the second ordering of the vertices, the decoding of motion information being performed according to the reindexing.

In some embodiments, the traversing is performed to increase an average prediction degree of the vertices between the first ordering and the second ordering.

In some embodiments, the traversing is performed according to a prediction-degree-based traversal method. In some embodiments, the traversing is performed according to a depth-first traversal method.

In some embodiments, the encoding of motion information comprises: for at least one current vertex in the mesh, predicting motion information of the vertex based only on motion information of one or more vertices preceding the current vertex according to the second ordering.

In some embodiments, the encoding of motion information comprises: for each of a plurality of vertices in the mesh, predicting motion information of the respective vertex based only on motion information of one or more vertices preceding the respective vertex according to the second ordering.

Some embodiments further include signaling, in a bitstream encoding the mesh information, information providing an indication to reindex the vertices.

Some embodiments further include signaling, in a bitstream encoding the mesh information, information identifying a type of traversal used for traversing the mesh.

A mesh decoding apparatus according to some embodiments comprises one or more processors configured to perform at least: obtaining mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and decoding motion information of the vertices according to the second ordering of the vertices.

In some embodiments, the mesh information defining at least one connected component of a mesh is obtained in an edgebreaker format.

In some embodiments, the corner table includes, for each corner, a first vertex index identifying the vertex associated with the respective corner, the first vertex indices being arranged in the first ordering; and the apparatus is further configured to reindex the vertices according to the second ordering of the vertices, the decoding of motion information being performed according to the reindexing.

In some embodiments, the traversing is performed to increase an average prediction degree of the vertices between the first ordering and the second ordering.

In some embodiments, the traversing is performed according to a prediction-degree-based traversal method.

In some embodiments, the traversing is performed according to a depth-first traversal method.

In some embodiments, the decoding of motion information comprises: for at least one current vertex in the mesh, predicting motion information of the vertex based only on motion information of one or more vertices preceding the current vertex according to the second ordering.

In some embodiments, the decoding of motion information comprises: for each of a plurality of vertices in the mesh, predicting motion information of the respective vertex based only on motion information of one or more vertices preceding the respective vertex according to the second ordering.

In some embodiments, the apparatus is further configured to obtain, from a bitstream encoding the mesh information, information indicating whether to reindex the vertices; wherein the traversing of the mesh to obtain the second ordering is performed only in response to an indication to reindex the vertices.

In some embodiments, the apparatus is further configured to obtain, from a bitstream encoding the mesh information, information identifying a type of traversal; wherein the traversing of the mesh to obtain the second ordering is performed using the identified type of traversal.

A mesh encoding apparatus according to some embodiments comprising one or more processors configured to perform at least: encoding mesh information defining at least one connected component of a mesh; decoding at least a portion of the mesh information to generate a corner table, the corner table associating each corner of the mesh with a respective vertex from among a plurality of vertices in the mesh, the vertices having a first ordering; traversing the mesh to obtain a second ordering of the vertices; and encoding motion information of the vertices according to the second ordering of the vertices.

In some embodiments, the mesh information defining at least one connected component of a mesh is encoded in an edgebreaker format.

In some embodiments, the corner table includes, for each corner, a first vertex index identifying the vertex associated with the respective corner, the first vertex indices being arranged in the first ordering; and the apparatus is further configured to reindex the vertices according to the second ordering of the vertices, the decoding of motion information being performed according to the reindexing.

In some embodiments, the traversing is performed to increase an average prediction degree of the vertices between the first ordering and the second ordering.

In some embodiments, the traversing is performed according to a prediction-degree-based traversal method.

In some embodiments, the traversing is performed according to a depth-first traversal method.

In some embodiments, the encoding of motion information comprises: for at least one current vertex in the mesh, predicting motion information of the vertex based only on motion information of one or more vertices preceding the current vertex according to the second ordering.

In some embodiments, the encoding of motion information comprises: for each of a plurality of vertices in the mesh, predicting motion information of the respective vertex based only on motion information of one or more vertices preceding the respective vertex according to the second ordering.

Some embodiments further include signaling, in a bitstream encoding the mesh information, information providing an indication to reindex the vertices.

Some embodiments further include signaling, in a bitstream encoding the mesh information, information identifying a type of traversal used for traversing the mesh.

An apparatus according to some embodiments comprises at least one processor and a computer-readable medium storing instructions for performing any of the methods described herein.

A computer-readable medium according to some embodiments stores instructions for performing any of the methods described herein.

A computer-readable medium according to some embodiments stores a mesh encoded according to any of the methods described herein.

A signal according to some embodiments conveys a mesh encoded according to any of the methods described herein.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to mesh encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. A mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A mesh decoding method comprising:
obtaining mesh information defining a topology of at least one connected component of a mesh;
decoding at least a portion of the mesh information to generate a corner table, the corner table associating each corner of the mesh with a respective vertex from among a plurality of vertices in the mesh, the vertices having a first ordering;
traversing the mesh to obtain a second ordering of the vertices; and
decoding motion information of the vertices according to the second ordering of the vertices.

2. A mesh decoding apparatus comprising one or more processors configured to perform at least:
obtaining mesh information defining a topology of at least one connected component of a mesh;
decoding at least a portion of the mesh information to generate a corner table, the corner table associating each corner of the mesh with a respective vertex from among a plurality of vertices in the mesh, the vertices having a first ordering;
traversing the mesh to obtain a second ordering of the vertices; and
decoding motion information of the vertices according to the second ordering of the vertices.

3. The apparatus of claim 2, wherein the mesh information comprises a CLERS table.

4. The apparatus of claim 2, wherein the traversing is performed to increase an average prediction degree of the vertices between the first ordering and the second ordering.

5. The apparatus of claim 2, wherein the traversing is performed according to a prediction-degree-based traversal method.

6. (canceled)

7. The apparatus of claim 2, wherein the corner table includes, for each corner, a first vertex index identifying the vertex associated with the respective corner, the first vertex indices being arranged in the first ordering, and wherein the vertices are reindexed according to the second ordering of the vertices, the decoding of motion information being performed according to the reindexing.

8. (canceled)

9. A mesh encoding method comprising:
encoding mesh information defining a topology of at least one connected component of a mesh;
decoding at least a portion of the mesh information to generate a corner table, the corner table associating each corner of the mesh with a respective vertex from among a plurality of vertices in the mesh, the vertices having a first ordering;
traversing the mesh to obtain a second ordering of the vertices; and
encoding motion information of the vertices according to the second ordering of the vertices.

10. A mesh encoding apparatus comprising one or more processors configured to perform at least:
encoding mesh information defining a topology of at least one connected component of a mesh;
decoding at least a portion of the mesh information to generate a corner table, the corner table associating each corner of the mesh with a respective vertex from among a plurality of vertices in the mesh, the vertices having a first ordering;
traversing the mesh to obtain a second ordering of the vertices; and
encoding motion information of the vertices according to the second ordering of the vertices.

11. The apparatus of claim 10, wherein the mesh information comprises a CLERS table.

12. The apparatus of claim 10, wherein the traversing is performed to increase an average prediction degree of the vertices between the first ordering and the second ordering.

13. The the apparatus of claim 10, wherein the traversing is performed according to a prediction-degree-based traversal method.

14. The apparatus of claim 10, wherein the corner table includes, for each corner, a first vertex index identifying the vertex associated with the respective corner, the first vertex indices being arranged in the first ordering, and wherein the vertices are reindexed according to the second ordering of the vertices, the encoding of motion information being performed according to the reindexing.

15. (canceled)

16. The method of claim 1, wherein the mesh information comprises a CLERS table.

17. The method of claim 1, wherein the traversing is performed to increase an average prediction degree of the vertices between the first ordering and the second ordering.

18. The method of claim 1, wherein the traversing is performed according to a prediction-degree-based traversal method.

19. The method of claim 1, wherein the corner table includes, for each corner, a first vertex index identifying the vertex associated with the respective corner, the first vertex indices being arranged in the first ordering, and wherein the vertices are reindexed according to the second ordering of the vertices, the decoding of motion information being performed according to the reindexing.

20. The method of claim 9, wherein the mesh information comprises a CLERS table.

21. The method of claim 9, wherein the traversing is performed to increase an average prediction degree of the vertices between the first ordering and the second ordering.

22. The method of claim 9, wherein the traversing is performed according to a prediction-degree-based traversal method.

23. The method of claim 9, wherein the corner table includes, for each corner, a first vertex index identifying the vertex associated with the respective corner, the first vertex indices being arranged in the first ordering, and wherein the vertices are reindexed according to the second ordering of the vertices, the encoding of motion information being performed according to the reindexing.
